(19) United States
(12) Patent Application Publication
(10) Pub. No.: US 2023/0263136 A1
(43) Pub. Date: Aug. 24, 2023

(54) The Bully Gun

(71) Applicant: John E. Lamarr, JR., Grand Rapids, MI (US)

(72) Inventor: John E. Lamarr, JR., Grand Rapids, MI (US)

(21) Appl. No.: 18/171,059

(22) Filed: Feb. 17, 2023

Related U.S. Application Data
(60) Provisional application No. 63/312,180, filed on Feb. 21, 2022.

(51) Int. Cl. A01K 15/02

(52) U.S. Cl. CPC A01K 15/025

(57) ABSTRACT

A system that is used to entertain dogs and cats. The system includes a toy gun that propels at least one soft toy or ball which is tethered to the toy gun and then retracted using a winding mechanism in the toy gun. The toys or balls can be coated or wrapped by tough material and the tether can be an elastomeric cord. A dog or cat will chase or tug on the toys or balls for amusement and exercise.

### REFERENCE TO RELATED APPLICATIONS

This application claims the benefit under 35 U.S.C. § 119(e) on U.S. Provisional Application No. 63/312,180 entitled “THE BULLY GUN,” filed on Feb. 21, 2022, by John E. Lamarr, Jr., the entire disclosure of which is incorporated by reference.

### BACKGROUND OF THE INVENTION

Dogs enjoy retrieving various types of objects such as sticks, balls, flying discs, and the like. Many breeds have an enhanced enjoyment in “playing fetch” in that such activities have been bred into such lines. Retrievers, bird dogs, and gun dogs have been bred to retrieve game foul, spaniels to flush birds from the brush, and other such similar activities.

A wide variety of animal toys are known. One kind of toy is made of hard rubber and comes in a variety of shapes. For example, a dog done made of tough, hard rubber has long been sold in retail outlets. A hard, tough rubber is utilized to make it difficult for a dog to chew through the bone. The rubber also adds weight to the toy, permitting the toy to be thrown long distances. Finally, the rubber material used to make the toy also enables the toy bone to bounce into the air. Dogs like chasing bouncing toys.

One type of retrieval training toy comprises a piece of rope or cord attached to a plastic body or to a body comprised of a small canvas bag filled with a pliable material like sawdust, sand, small pieces of paper, etc. A trainer or other individual utilizes a retrieval toy by grasping the piece of rope and using the rope to throw the toy. The dog or other animal retrieving the toy takes the rope or the body and carries the toy back to the trainer. These kinds of retrieval training toys ordinarily are not sealed or do not bounce.

There is a need for a durable dog fetch and retrieve toy that is capable of providing the stimulus that triggers the animal's instinctive retrieving behaviors. It is an object of the present invention to provide such as toy.

Many devices for promoting play and interaction between pet and owner are in existence today. U.S. Pat. No. 6,401,655 discloses a bolo-type retrieval toy. Other toys include those resembling a fishing pole with a toy-like object carried on the end of a string. These toys can entertain a cat, dog, or other pet; however, the pet may see the toy and realize that a human is indirectly operating the toy.

Motor powered toys are also known. U.S. Pat. No. 7,631,617 discloses a moving pet toy secured to a home fixture. These toys have a supported toy-like object that is moved mechanically in a manner that may attract the pet. However, this type of device does not promote interaction between the pet and the owner.

The above games tend to be of a type that may be labeled “pursuit-type” games, in that the toy is moved, either by the owner or a machine, and the pet chases it. This type of game depends for its entertainment value on the pet being close enough to success in catching the toy to make the pet attempt to catch it, yet not close enough that it is overly easy. Such games often become equated by the pet to the game of “fetch.” Some pets are simply uninterested in this game.

Accordingly, there is a need for a toy that can amuse animals such as dogs and cats by inducing the animal to chase an object, but which will not overly tax the human.

Therefore, it is a principal object of the instant invention to provide such an improved toy.

Still a further object of the invention is to provide an improved toss-and-retrieve animal husbandry device which includes a tether attached to the toy, where the toy is sealed, and where the toy bounces.

### DESCRIPTION

Other objects, features and advantages of the invention will become apparent from a consideration of the following detailed description and the accompanying drawings.

Referring to the figures, it can be understood that the present invention is embodied in a system for amusing and exercising dogs. The toy gun system 10 includes a toy gun 50 that fires balls 30 that are suitable for use with cats and dogs. The balls 30 are coated or wrapped with a tough material and are connected to the toy gun 50 by a tether 40, such as a bungee cord. The balls 30 can be of any suitable size, including soccer-ball size. The barrel 60 has means for propelling the balls 30. A winding mechanism 20, for the tether 40, is located in the toy gun 50 to retrieve the balls 30 after they have been propelled. The winding mechanism 20 has means release the tension on the tether 40 allowing the balls 30 to propel from the barrel 20.

As indicated in FIG. 1, multiple balls 30 can be included with, propelled by, and retrieved by the system.

First form 10 of the system includes a ground-mounted toy gun 50. The second form 10′ of the system includes an arm-mountable toy gun 50′. The third form 10″ of the system includes a hand-holdable toy gun 50″. It is understood that while certain forms of the present invention have been illustrated and described, the invention is not to be limited to the specific forms or arrangements or parts described and shown.

### SUMMARY OF THE INVENTION

These and other objects are achieved by a system that is used to entertain dogs and cats. According to one aspect of the present invention, a system is provided comprising a toy gun and a soft ball, an tether that is connected on one end to the soft ball and on the other end to the toy gun, that tether running through the interior of the barrel of the toy gun, that tether being connected to a releasable winding mechanism that is located in the toy gun, that toy gun having means to propel the ball from the barrel, and that releasable winding mechanism being capable of retracting the tether and retrieving the ball into the barrel. The ball can be coated or wrapped by a tough material. The tether can be an elastomeric bungee cord. A dog or cat will chase the ball and engage in tugging for amusement and exercise. These and other features, advantages, and objects of the present invention will be further understood and appreciated by those skilled in the art by reference to the specification, claims, and appended drawings.

### TECHNICAL FIELD OF THE INVENTION

The present invention relates, in general, to animal husbandry, and, more particularly, to amusement devices for use with animals, such as cats and dogs.

### BRIEF DESCRIPTION OF DRAWINGS

The present invention will become more fully understood from the detailed description and the accompanying drawings, in which:

FIG. 1 is a perspective view of a first form 10 of the system embodying the present invention;

FIG. 2 is a side elevational view of another form 10′ of the system embodying the present invention;

FIG. 3 is a side elevational view of yet another form 10″ of the system embodying the present invention; and

FIG. 4 is a side elevational view of a ball used in the system embodying the present invention.

### BEST MODE FOR CARRYING OUT THE INVENTION

The second form 10′ of the system is the best mode for carrying out the invention.

### DETAILED DESCRIPTION OF DRAWINGS

The present illustrated embodiments reside primarily in combinations of apparatus components related to a device for propulsion and retrieval of an object. Accordingly, the apparatus components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description. Further, like numerals in the description and drawings represent like elements. However, the disclosure may assume various alternative orientations, except where expressly specified to the contrary. The specific devices illustrated in the attached drawings and described in the following specification are simply exemplary embodiments of the inventive concepts defined in the appended claims. Specific dimensions and other physical characteristics relating to the embodiments disclosed here are not to be considered as limiting, unless the claims expressly state otherwise.

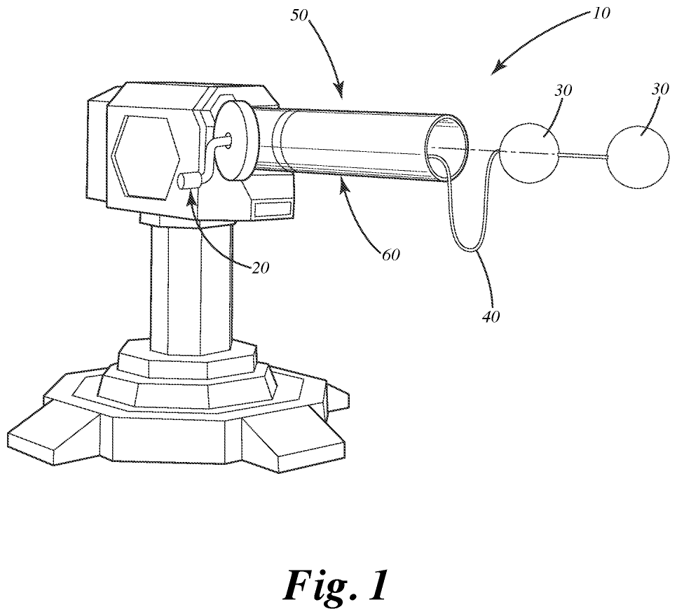

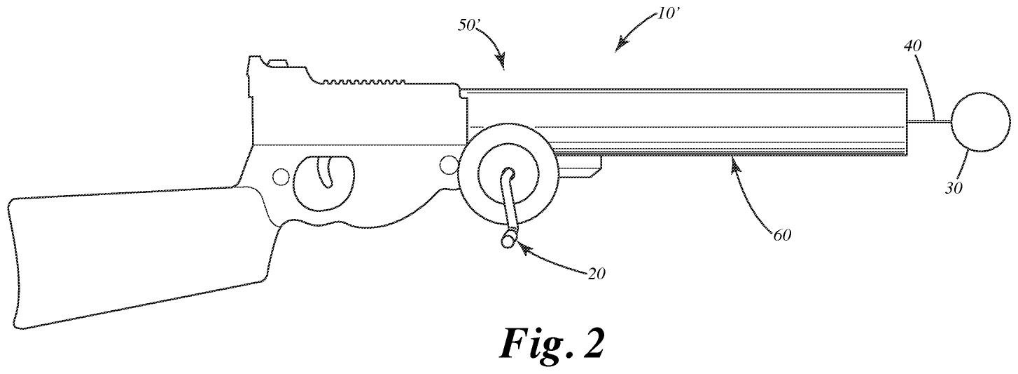

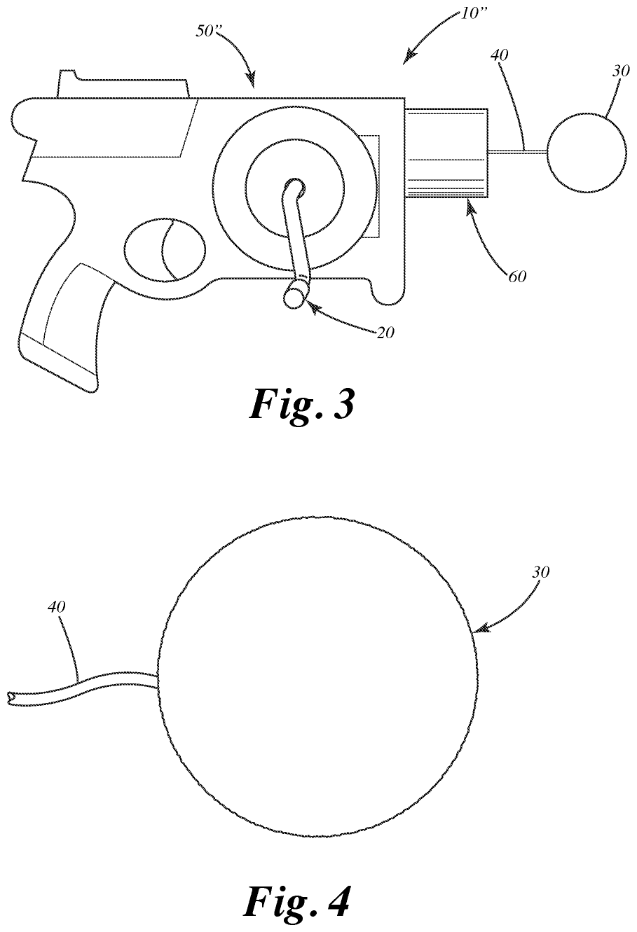

Referring to FIGS. 1, 2, and 3, reference numeral 10 generally designates a toy gun system and 50 generally designates a toy gun. The toy gun 50 may be used for entertaining a dog or cat with a game comprising the operator using the toy gun 50 to propel the ball 30 away from the operator, the animal fetching the ball 30, the animal retrieving the ball 30, and the animal tugging on the ball 30 while the operator interactively resists the motion with the winding mechanism 20. Although this particular application of the toy gun 50 is described, the toy gun 10 may be used in various other applications and the description of entertainment of a dog or cat is not intended to be limiting.

Three embodiments of the toy gun system 10 are shown in FIGS. 1-3, Each of the embodiments includes advantageous aspects including the aspect to secrete the ball 30 or balls 30 inside the barrel 60 of the toy gun 50, which provides the element of a revealed surprise and subsequent stimulus to the animal. The embodiments also include the tether 40, which when coupled with the winding mechanism 20, allow for a vigorous tugging and pulling play between the operator and the animal. The embodiments also include means to propel the ball 30, decreasing the physical exertion of the operator.

The construction and arrangement of the elements of the disclosure as shown in the exemplary embodiments is illustrative only. Although only a few embodiments of the present innovations have been described in detail, those skilled in the art who review this disclosure will readily appreciate that many modifications are possible (e.g., variations in sizes, dimensions, structures, shapes and proportions of the various elements, values of parameters, mounting arrangements, use of materials, orientations, etc.) without materially departing from the novel teachings and advantages of the subject matter recited. For example, the length or width of the structures and members or other elements of the assembly may be varied. It should be noted that the elements and assemblies of the assembly may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

The above description is considered that of the preferred embodiments only.

Modifications of the invention will occur to those skilled in the art and to those who make or use the invention. Therefore, the embodiments shown in the drawings and described above are merely for illustrative purposes and not intended to limit the scope of the invention, which is defined by the claims as interpreted according to the principles of patent law, including the doctrine of equivalents.

What is claimed is:

1. A toy gun device comprising:
a barrel with a proximate end and a distal end, a winding mechanism, a tether with a proximate end and a distal end, at least one toy, said barrel having an interior and exterior, said winding mechanism being connected to said proximate end of said barrel, said proximate end of said tether being connected to said winding mechanism, said distal end of said tether being connected to said toy, said tether running through said interior of said barrel, said barrel having means to propel said toy away from said distal end of said barrel, said winding mechanism having means to develop tensional force in said tether, and said winding mechanism having means for releasing said tensional force from said tether.

2. The toy gun device of claim 1 further comprising said toy being at least one ball.

3. The toy gun device of claim 2 further comprising said ball made of an elastomeric material such that said ball bounces.

4. The toy gun device of claim 1 further comprising said toy that is attractive to animals.

5. The toy gun device of claim 1 further comprising said tether constructed from an elastomeric material.

6. The toy gun device of claim 1 further comprising said barrel distal end having means to hold said toy to said barrel distal end when said tether is under said tensional force.

7. The toy gun device of claim 1 further comprising said barrel having interior dimensions large enough to hold said toy in said interior of said barrel.

8. The toy gun device of claim 1 further comprising said winding mechanism with means for adjustable friction drag on said tether.

9. The toy gun device of claim 1 further comprising said means to develop said tensional force in winding mechanism is motorized.

10. The toy gun device of claim 1 further comprising a means to affix said barrel to the ground or a non-moving base.

11. The toy gun device of claim 1 further comprising said winding mechanism having means to develop the energy required for propelling said toy away from said distal end of said barrel.

12. A toy gun device comprising:
a barrel with a proximate end and a distal end, a winding mechanism, a tether with a proximate and distal end, at least one toy, said barrel having an interior and exterior, said winding mechanism being connected to said proximate end of said barrel, said proximate end of said tether being connected to said winding mechanism, said distal end of said tether being connected to said toy, said tether running through said interior of said barrel, said barrel having means to propel said toy away from said distal end of said barrel, said winding mechanism having means to develop tensional force in said tether, said winding mechanism having means for releasing said tensional force from said tether, said toy being at least one ball, said ball made of an elastomeric material such that the ball bounces, said toy that is attractive to animals, said tether constructed from an elastomeric material, and said winding mechanism with means for adjustable friction drag on said tether.

13. The toy gun device of claim 12 further comprising said barrel having distal end with means to hold said toy to said barrel distal end when said tether has said tensional force.

14. The toy gun device of claim 12 further comprising said barrel having interior dimensions large enough to hold said toy in said interior of said barrel.

15. The toy gun device of claim 12 further comprising said means to develop said tensional force in winding mechanism is motorized.

16. The toy gun device of claim 12 further comprising a means to affix said barrel to an external base object.

17. The toy gun device of claim 12 further comprising said winding mechanism having means to develop the energy required for propelling said toy away from said distal end of said barrel.
